(19) United States
(12) Patent Application Publication
(10) Pub. No.: US 2024/0153667 A1
(43) Pub. Date: May 9, 2024

(54) SEMICONDUCTIVE POLYMER COMPOSITION

(71) Applicant: BOREALIS AG, Vienna (AT)

(72) Inventors: Niklas THORN, Stenungsund (SE); Daniel NILSSON, Stenungsund (SE); Johannes THUNBERG, Stenungsund (SE); Annika SMEDBERG, Stenungsund (SE)

(21) Appl. No.: 18/282,084

(22) PCT Filed: Mar. 15, 2022
(86) PCT No.: PCT/EP2022/056755

§ 371 Date: Sep. 14, 2023

(30) Foreign Application Priority Data
Mar. 16, 2021 (EP) 21162987.8

(51) Int. Cl. H01B 3/44; H01B 3/00; H01B 13/14; H01B 19/00

(52) U.S. Cl. CPC H01B 3/447; H01B 3/004; H01B 3/441; H01B 13/141; H01B 13/148; H01B 19/00

(57) ABSTRACT

A semiconductive polymer composition comprising: (a) an ethylene alkyl (meth) acrylate copolymer; (b) 15 to 48 wt % carbon black having an iodine adsorption number of 85 to 140 mg/g (ASTM D 1510-19a), an oil absorption number of 90 to 110 ml/100 g (ASTM D 2414-19) and an average primary particle size of 29 nm or less (ASTM D 3849-14a); and (c) 0.05 to 2.0 wt % of 4,4′-bis(1,1′-dimethylbenzyl)diphenylamine; all weight percentages being based on the total weight of the semiconductive polymer composition.

This invention relates to a semiconductive polymer composition comprising a polyethylene polymer and carbon black. In particular, the invention relates to a semi-conducting composition comprising an ethylene alkyl (meth)acrylate copolymer, a specific carbon black and a specific antioxidant as well as the use of that composition in the manufacture of a semiconductive shield for an electric power cable. The invention also relates to cables comprising said semiconductive polymer composition.

### BACKGROUND OF THE INVENTION

Electric cables and particularly electric power cables for medium and high voltages are composed of a plurality of polymer based layers extruded around the electric conductor. The electric conductor is usually coated first with an inner semi-conducting layer (the conductor shield) followed by an insulating layer, then an outer semi-conducting layer (the insulation shield). To these layers further layers may be added, such as a water barrier layer and sheath layer(s).

The insulating layer normally comprises an LDPE (low density polyethylene, i.e. polyethylene prepared by radical polymerisation at a high pressure) which may be cross-linked by adding peroxide. The inner and outer semi-conducting layers normally comprises an ethylene copolymer, such as an ethylene-vinyl acetate copolymer (EVA) or ethylene alkyl (meth)acrylate copolymer with an amount of carbon black sufficient to make the composition semi-conducting.

There is a need to improve the smoothness of a semiconductive layer in a power cable. Inhomogeneities present in such layers can have detrimental effects on the performance of the power cable since an inhomogeneity or protrusion will lead to a field enhancement and a weak point in the cable. It is therefore desirable to produce smoother semiconductive layers with cost competitive components.

It is also preferred if the semi-conducting layer has a high conductivity (low volume resistivity) to fulfil its purpose as a semi-conducting shield. Further, the semi-conducting composition should be easy to process into a semi-conducting shield layer. This means that the composition should have low viscosity when processed. The viscosity of the composition may be measured as the melt flow rate (MFR) of the composition, where a high MFR value means a low viscosity.

EP1630823 describes a semiconductive polymer composition comprising an olefin homo- or copolymer wherein the composition has a direct current volume resistivity of less than 1000 Ohm·cm at 90° C., an elongation at break which after aging for 240 hours at 135° C. does not change by more than 25%, and a total number of structures of 20 or less in the SI ED test.

EP 2628162 describes semiconductive compositions containing a polyolefin, carbon black and antioxidant. In the examples of EP 2628162, an antioxidant is combined with EMA or EBA and with carbon black. Three carbon blacks are discussed in the examples EP 2628162. None meet the requirements of claim 1.

EP 2886585 describes a semiconductive polymer composition with improved smoothness and dispersability of carbon black. The carbon black is defined in terms of its mass pellet strength. The invention in EP 2886585 is based on the finding that the modification of the pellet crush resistance of a conventional carbon black gives an excellent surface smoothness. Properties of the carbon black are defined in paragraph [0017] of EP 2886585. The iodine adsorption number is defined as 20 to 60 g/kg, this is entirely outside the range we claim (85 to 140 mg/g).

EP 1548752 describes a semi-conductive composition which comprises an ethylene alkyl (meth)acrylate copolymer and a carbon black. There is no teaching of the use of 4,4′-bis(1,1′-dimethylbenzyl)diphenylamine.

EP 1065672 describes a semiconductive composition comprising carbon black with (a) a particle size of at least 29 nm, (b) a tint strength of less than 100%, (c) a loss of volatiles at 950° C. in a nitrogen atmosphere of less than 1 wt %, (d) a DBP oil absorption of 80-300 cm3/100 g, (e) a nitrogen surface adsorption area of 30-300 m2/g or an iodine adsorption number of 30-300 g/kg, (f) a CTAB surface area of 30-150 m2/g and (g) a ratio of property (e) to property (f) of greater than about 1.1. The compositions described in EP 1065672 have improved resistivity and smoothness. The antioxidant TMQ is used in the examples.

The present inventors have now found that certain conductive carbon blacks, when combined with an ethylene alkyl (meth)acrylate copolymer and a specific antioxidant offer remarkable surface smoothness. Normally, an antioxidant is present in a semiconductive polymer composition to provide thermo-oxidative stability. Traditionally a TMQ type of antioxidant is used as antioxidant, e.g. as described in EP1548752. In EP1548752, a semi-conductive polymer composition is described which comprises an ethylene alkyl (meth)acrylate copolymer, a carbon black wherein the carbon black is a furnace black having a DBPA of 90-110 cm³/100 g; an iodine adsorption number of 85-140 g/kg; and a particle size of less than 29 nm, and a TMQ antioxidant.

It has now been found that using an aromatic amine antioxidant of formula 4,4′-bis(1,1′-dimethylbenzyl)diphenylamine (CAS-no. 10081-67-1) in combination with a carbon black, e.g. the carbon black as described in EP1548752, provides similar thermo-oxidative ageing properties but improves the smoothness of shield layers made with such a composition. This improvement is also achieved with an improvement in volume resistivity and with high MFR ethylene alkyl (meth)acrylate copolymers. There appears therefore to be a synergy between the specific carbon black and the 4,4′-bis(1,1′-dimethylbenzyl)diphenylamine antioxidant. The invention therefore relates to the smoothness improvement achieved with 4,4′-bis(1,1′-dimethylbenzyl)diphenylamine as the antioxidant when used in a semiconductive polymer composition using a specific carbon black as defined herein.

### SUMMARY OF THE INVENTION

Thus viewed from one aspect the invention provides a semiconductive polymer composition comprising:
(a) an ethylene alkyl (meth)acrylate copolymer;
(b) 15 to 48 wt % carbon black having an iodine adsorption number of 85 to 140 mg/g (ASTM D 1510-19a), an oil absorption number of 90 to 110 ml/100 g (ASTM D 2414-19) and an average primary particle size of 29 nm or less (ASTM D 3849-14a); and
(c) 0.05 to 2.0 wt % of 4,4′-bis(1,1′-dimethylbenzyl)diphenylamine;
all weight percentages being based on the total weight of the semiconductive polymer composition.

Viewed from another aspect the invention provides a process for the preparation of a semiconductive polymer composition as herein before defined comprising compounding components (a) to (c) at a temperature of 150 to 300° C., preferably via mixing;
and optionally pelletizing the composition.

In particular, compounding can be effected in a co-kneader.

Viewed from another aspect the invention provides a cable, such as a power cable, comprising a conductor which is surrounded by at least an inner semiconductive layer, an insulation layer and an outer semiconductive layer in that order;
wherein said inner and/or outer semiconductive layer comprises, e.g. consists of, a semiconductive polymer composition as herein before defined.

Viewed from another aspect the invention provides a process for producing a cable, such as a power cable, comprising a conductor surrounded by at least an inner semiconductive layer, an insulation layer and an outer semiconductive layer, in that order, wherein the process comprises the steps of;
extruding on a conductor an inner semiconductive layer, an insulation layer and outer semiconductive layer; and
optionally crosslinking one or more of said inner semiconductive layer, insulation layer and outer semiconductive layer;
wherein said inner and/or outer semiconductive layer comprises, e.g. consists of, a semiconductive polymer composition as herein before defined.

Viewed from another aspect the invention provides the use of a semiconductive polymer composition as hereinbefore defined in the manufacture of the inner and/or outer semiconductive layer of a cable, such as a power cable.

Viewed from another aspect the invention provides the use of a semiconductive polymer composition comprising:
(a) an ethylene alkyl (meth)acrylate copolymer;
(b) 15 to 48 wt % carbon black having an iodine adsorption number of 85 to 140 mg/g (ASTM D 1510-19a), an oil absorption number of 90 to 110 ml/100 g (ASTM D 2414-19) and an average primary particle size of 29 nm or less (ASTM D 3849-14a); and
(c) 0.05 to 2.0 wt % of 4,4′-bis(1,1′-dimethylbenzyl)diphenylamine;
all weight percentages being based on the total weight of the semiconductive polymer composition;
to increase the smoothness of a semiconductive shield layer prepared using said composition.

### DETAILED DESCRIPTION OF INVENTION

This invention relates to a semiconductive polymer composition comprising an ethylene alkyl (meth)acrylate copolymer, a specific carbon black and 4,4-′bis(1,1′-dimethylbenzyl)diphenylamine. The composition offers remarkably smooth semiconductor shield layers in cables.

### Carbon Black

According to the present invention, the semiconductive polymer composition comprises a specific carbon black. It is possible to use a mixture of carbon blacks or a single carbon black. Ideally, a single carbon black is used. Any wt % referred to below refer to the total weight of carbon black present in the semiconductive polymer composition based on the total weight of the semiconductive polymer composition.

Preferably, the semiconductive polymer composition comprises 15 to 48 wt % carbon black. In further preferred embodiments, the amount of carbon black is 15 to 45 wt %, preferably 20 to 45 wt %, such as 25 to 45 wt %, more preferably 30 to 42 wt %, or especially 35 to 41 wt %, based on the total weight of the semiconductive polymer composition. In one embodiment, the amount of carbon black is 36-40 wt % based on the total weight of the semiconductive polymer composition.

The carbon black used in the compositions of the invention is one that has an oil absorption number (OAN) of 90-110 ml/100 g; an iodine adsorption number (I₂) of 85-140 g/kg; and an average primary particle size of 29 nm or less. This carbon black has been found to work well in the semiconductive polymer composition of the invention and also has significant cost advantages compared to other speciality carbon blacks used for conductivity.

The carbon black is preferably a furnace black.

The presence of the carbon black ensures that the semiconductive polymer composition is semiconductive.

A semi-conductive polymer composition defined here preferably has a volume resistivity (VR) at 23° C. of less than 100 Ohm·cm, preferably less than 50 Ohm·cm, more preferably less than 25 Ohm·cm and even more preferably less than 10 Ohm·cm measured according to the test method described below. The volume resistivity (VR) may be more than 1.0 Ohm·cm. A preferred range is 1.0 to 6.0 Ohm·com.

The bulkiness of the carbon black can be expressed as the oil absorption number in ml/100 g (or cm³/100 g) according to ASTM D 2414-19. The OAN number of the carbon black of the present invention is 90-110 ml/100 g, preferably 92-105 ml/100 g, more preferably 92-104 ml/100 g.

The surface area of the carbon black is expressed as the iodine adsorption (I₂) number in g/kg (or mg/g) according to ASTM D 1510-19a. The iodine adsorption number of the carbon black of the present invention is 85-140 g/kg, preferably 100-140 g/kg, and more preferably 110-135 g/kg.

The average primary particle size of the carbon black relates to the primary particle size and is expressed as the arithmetic mean particle diameter measured in nanometers (nm) with transmission electron microscopy according to ASTM D 3849-14a. The average primary particle size of the carbon black of the present invention is 29 nm or less, preferably 25 nm or less, more preferably 20 nm or less. The average primary particle size may be 11 nm or more.

In a preferred embodiment, the carbon black has an iodine adsorption number of 100 to 130 mg/g, an oil absorption number of 92 to 105 ml/100 g and an average primary particle size of 25 nm or less.

As preferred examples of carbon blacks according to the present invention may be mentioned Raven P-FE/B (I₂=118 g/kg; OAN=98 ml/100 g; average primary particle size 20 nm); and Printex Alpha A (I₂=118 g/kg; OAN=98 ml/100 g; average primary particle size 20 nm).

### Ethylene Alkyl (Meth)Acrylate Copolymer

According to the present invention, the semiconductive polymer composition comprises a copolymer of ethylene and an alkyl (meth)acrylate comonomer. It is possible to use a mixture of ethylene alkyl (meth)acrylate copolymers. Ideally, a single ethylene alkyl (meth)acrylate copolymer is used. Any wt % referred to below refer to the total weight of ethylene alkyl (meth)acrylate copolymers present in the semiconductive polymer composition based on the total weight of the semiconductive polymer composition, unless mentioned otherwise.

The copolymer used in the semiconductive polymer composition is a copolymer of ethylene and an alkyl (meth)acrylate comonomer. The term (meth)acrylate implies either methacrylate or acrylate herein. It is preferred if the copolymer is an ethylene alkyl acrylate. There may be one or more alkyl (meth)acrylate comonomers, preferably one alkyl (meth)acrylate comonomer only. It is preferred if no non alkyl (meth)acrylate comonomers are present.

Further preferably, said comonomer(s) is selected from C₁- to C₆-alkyl acrylates, or C₁- to C₆-alkyl methacrylates. Still more preferably, the copolymer used in the semiconductive polymer composition is a copolymer of ethylene with a C₁- to C₄-alkyl methacrylate or C₁- to C₄-alkyl acrylate, such as methyl, ethyl, propyl or butyl acrylate.

The use of ethylene methyl acrylate (EMA) copolymer, ethylene methyl methacrylate (EMMA) copolymer, ethylene ethyl acrylate (EEA) copolymer, or ethylene butyl acrylate (EBA) copolymer is preferred.

The use of ethylene methyl acrylate (EMA), ethylene butyl acrylate (EBA) or ethylene ethyl acrylate (EEA) is preferred

The use of ethylene methyl acrylate (EMA) or ethylene ethyl acrylate (EEA) is most preferred.

The copolymer preferably comprises 5 to 30 wt %, preferably 7 to 25 wt %, more preferably 8 to 20 wt %, especially 9 to 20 wt % of alkyl (meth)acrylate comonomer based on the total weight of the ethylene alkyl (meth)acrylate copolymer. In one embodiment, the copolymer comprises 10 to 20 wt % of alkyl (meth)acrylate comonomer, such as 12 to 20 wt %, especially 14 to 20 wt % based on the total weight of the ethylene alkyl (meth)acrylate copolymer. The ethylene preferably forms the balance of the ethylene alkyl (meth)acrylate copolymer, i.e. there is preferably at least 70 wt % ethylene monomer present, such as 70 to 95 wt %, 75 to 93 wt %, 80 to 92 wt %, 80 to 91 wt % or 80 to 90 wt % ethylene based on the total weight of the ethylene alkyl (meth)acrylate copolymer.

Preferably, the ethylene alkyl (meth)acrylate copolymer has a melt flow rate MFR 2 of 0.1 to 50 g/10 min, more preferably 1.0 to 30 g/10 min, even more preferably 2.0 to 25 g/10 min, and most preferably 4.0 to 22 g/10 min (ISO 1133, 2.16 kg. 190° C.). Most preferred ranges include 4.0 to 15 g/10 min, or 4.5 to 12 g/10 min.

In one embodiment, the ethylene alkyl (meth)acrylate copolymer comprises 9 wt % or more of said alkyl (meth)acrylate comonomer; based on the total weight of the ethylene alkyl (meth)acrylate copolymer; and has an MFR 2 of 4.5 g/10 min or more (determined using ISO 1133 190° C. and 2.16 kg load).

In one embodiment, the ethylene alkyl (meth)acrylate copolymer comprises 10 to 20 wt % of said alkyl (meth)acrylate comonomer, based on the total weight of the ethylene alkyl (meth)acrylate copolymer, and has an MFR 2 of 4.0 to 15 g/10 min (determined using ISO 1133 190° C. and 2.16 kg load).

Any ethylene alkyl (meth)acrylate copolymer may have a density of 910 to 940 kg/m³, preferably 915 to 940 kg/m³, such as 920 to 940 kg/m³.

The ethylene alkyl (meth)acrylate copolymer can be produced by any conventional polymerisation process. Preferably, it is produced by radical polymerisation, such as high pressure radical polymerisation. High pressure polymerisation can be effected in a tubular reactor or an autoclave reactor. Preferably, it is a tubular reactor. In general, the pressure can be within the range of 1200-3500 bars and the temperature can be within the range of 150° C.-350° C. Further details about high pressure radical polymerisation are known in the art. Suitable ethylene alkyl (meth)acrylate copolymers are available commercially.

The balance of the semiconductive polymer composition is formed by the ethylene alkyl (meth)acrylate copolymer once other components have been considered. The semiconductive polymer composition preferably comprises at least 51 wt %, such as at least 54 wt % of said ethylene alkyl (meth)acrylate copolymer such as 54 to 85 wt % based on the total weight of the semiconductive polymer composition. Other preferred options include 51 wt % or more based on the total weight of the semiconductive polymer composition. In further preferred embodiments, the amount of ethylene alkyl (meth)acrylate copolymer is 54 wt % or more, such as 59 wt % or more based on the total weight of the semiconductive polymer composition.

It is especially preferred if the copolymer is an ethylene ethyl acrylate copolymer and has 10 to 20 wt % of ethyl acrylate comonomer based on the total weight of the ethylene alkyl (meth)acrylate copolymer and preferably has a melt flow rate MFR 2 of 4.5 to 12 g/10 min.

### Antioxidant

The semiconductive polymer composition of the invention comprises the specific antioxidant 4,4′-bis(1,1′-dimethylbenzyl)diphenylamine.

The amount of this antioxidant is 0.05 to 2.0 wt % of semiconductive polymer composition, preferably 0.10 to 1.0 wt %, more preferably 0.15 to 0.80 wt % based on the total weight of the semiconductive polymer composition. Most especially, there is 0.20 to 0.60 wt % of 4,4′-bis(1,1′-dimethylbenzyl)diphenylamine based on the total weight of the semiconductive polymer composition.

The antioxidant 4,4′-bis(1,1′-dimethylbenzyl)diphenylamine is commercially available as Naugard® 445GR, Sanox 445 and Palmarole AO.A.405.

It is preferred if no other antioxidants are present.

### Other Components

The semiconductive polymer composition may comprise further additives. As possible additives, scorch retarders, crosslinking boosters, stabilisers, processing aids, flame retardant additives, acid scavengers, inorganic fillers, voltage stabilizers, additives for improving water tree resistance, or mixtures thereof can be mentioned.

A “scorch retarder” is defined to be a compound that reduces premature crosslinking i.e. the formation of scorch during extrusion. Besides scorch retarding properties, the scorch retarder may simultaneously result in further effects like boosting, i.e. enhancing crosslinking performance.

Useful scorch retarders can be selected from substituted or unsubstituted diphenylethylene, quinone derivatives, hydroquinone derivatives, monofunctional vinyl containing esters and ethers, or mixtures thereof. More preferably, the scorch retarder is selected from substituted or unsubstituted diphenylethylene, or mixtures thereof. A highly preferred option is 2,5-di-tert. butyl hydroquinone or 2,4-diphenyl-4-methyl-1-pentene, especially 2,4-diphenyl-4-methyl-1-pentene.

Preferably, the amount of scorch retarder is within the range of 0.005 to 1.0 wt %, more preferably within the range of 0.01 to 0.8 wt %, based on the total weight of the semiconductive polymer composition.

Typical cross-linking boosters may include compounds having an allyl group, e.g. triallylcyanurate, triallylisocyanurate, and di-, tri- or tetraacrylates.

Still a further embodiment of the present invention discloses a semiconductive polymer composition containing neither any crosslinking booster(s) nor any scorch retarder additive(s).

### Peroxide—Semiconductive Polymer Composition

A peroxide is preferably added to the semiconductive polymer composition in an amount of less than 3.0 wt %, more preferably 0.1 to 2.0 wt %, even more preferably 0.3 to 1.5 wt %, yet even more preferably 0.4 to 1.1 wt %, especially 0.5 to 0.8 wt % based on the total weight of the semiconductive polymer composition. Where a blend of peroxides is used then this percentage refers to the sum of the peroxides present.

The peroxide may be added to the semiconductive polymer composition during the compounding step (i.e. when the polymer is mixed with the carbon black), or after the compounding step in a separate process, or when the semiconductive polymer composition is extruded.

As peroxides used for crosslinking, the following compounds can be mentioned:
di-tert-amylperoxide, 2,5-di(tert-butylperoxy)-2,5-dimethyl-3-hexyne, 2,5-di(tert-butylperoxy)-2,5-dimethylhexane, tert-butylcumylperoxide, di(tert-butyl)peroxide, dicumylperoxide, butyl-4,4-di(tert-butylperoxy)-valerate, 1,1-di(tert-butylperoxy)-3,3,5-trimethylcyclohexane, tert-butylperoxybenzoate, dibenzoylperoxide, di(tert butylperoxyisopropyl)benzene, 2,5-dimethyl-2,5-di(benzoylperoxy)hexane, 1,1-di(tert-butylperoxy)cyclohexane, 1,1-di(tert amylperoxy)cyclohexane, or any mixtures thereof.

Preferably, the peroxide is selected from 2,5-di(tert-butylperoxy)-2,5-dimethylhexane, di(tert-butylperoxyisopropyl)benzene, dicumylperoxide, tert-butylcumylperoxide, di(tert-butyl)peroxide, or mixtures thereof.

In one embodiment, the semiconductive polymer composition is free of peroxide.

In one embodiment, the semiconductive polymer composition consists of:
(a) an ethylene alkyl (meth)acrylate copolymer;
(b) 15 to 48 wt % carbon black having an iodine adsorption number of 85 to 140 mg/g (ASTM D 1510-19a), an oil absorption number of 90 to 110 ml/100 g (ASTM D 2414-19) and an average primary particle size of 29 nm or less (ASTM D 3849-14a); and
(c) 0.05 to 2.0 wt % of 4,4′-bis(1,1′-dimethylbenzyl)diphenylamine;
all weight percentages being based on the total weight of the semiconductive polymer composition.

In embodiments wherein the semiconductive polymer composition is a crosslinkable composition, it may also comprise a crosslinking agent.

In one embodiment, the semiconductive polymer composition consists of:
(a) an ethylene alkyl (meth)acrylate copolymer;
(b) 15 to 48 wt % carbon black having an iodine adsorption number of 85 to 140 mg/g (ASTM D 1510-19a), an oil absorption number of 90 to 110 ml/100 g (ASTM D 2414-19) and an average primary particle size of 29 nm or less (ASTM D 3849-14a);
(c) 0.05 to 2.0 wt % of 4,4′-bis(1,1′-dimethylbenzyl)diphenylamine; and
(d) 0.1 to 2.0 wt % of a crosslinking agent such as a peroxide
all weight percentages being based on the total weight of the semiconductive polymer composition.

### Preparation of the Semiconductive Polymer Composition

The semi-conducting polymer composition may be prepared by incorporating the carbon black, antioxidant and any additives into the base ethylene alkyl (meth)acrylate copolymer. This is preferably done by compounding the base polymer, the carbon black, antioxidant and any additives in a compounding apparatus such as a Banbury mixer, co-kneader or a single or twin screw extruder.

The process for mixing and/or blending (e.g. compounding) components (a) to (c) may occur at a temperature below 300° C. Preferable temperature ranges include 155 to 280° C., such as 160 to 260° C.

This mixing at elevated temperature is typically referred to as melt mixing, and will usually occur at more than 10° C. above, preferably more than 25° C., above the melting point of the polymer component(s) and below the degradation temperature of components.

Preferably the preparation process further comprises a step of pelletising the obtained polymer composition. Pelletising can be affected in well-known manner using a conventional pelletising equipment, such as preferably conventional pelletising extruder which is integrated to said mixer device.

According to one embodiment, the semi-conducting polymer composition according to the present invention is prepared by using a co-kneader as the mixing apparatus comprising a mixer barrel in which the melt-mixing of the composition is carried out, e.g. with one inlet hopper for adding polymer, with one or more inlet hoppers for adding the carbon black, and a discharge extruder or gear pump arranged downstream of the mixer barrel.

The co-kneader may e.g. be a single-screw machine comprising an axial oscillation once per revolution, where static pins in a mixer house of the apparatus interact with gaps in the screw. Hereby, an elongational kneading, which provides efficient dispersive and distributive mixing in a relatively short barrel, is provided. Temperature can be controlled by adding the carbon black to the polymer melt in one or more hoppers.

The inventors have found that co-kneading compounding may further improve the smoothness. Compared to a batch wise or twin screw process, a co-kneading process offers improved cost efficiency but also a lower risk of contaminants entering the semiconductive polymer composition which could cause a decreased smoothness, and a lower risk of negatively affecting critical carbon black characteristics such as carbon black structure with a resultant negative effect on conductivity and dispersibility (and consequently also a decreased smoothness). The use of a BUSS co-kneader is preferred.

Cables can then be prepared from the semiconductive polymer composition as required.

### Conductor

The cable of the invention comprises a conductor. The conductor can be made from any suitable conductive metal, typically copper or aluminium.

### Cable

A further embodiment of the present invention provides a cable (e.g. a power cable), comprising at least one layer, wherein said layer comprises the semiconductive polymer composition as described herein.

The layer may comprise at least 50 wt % of the semiconductive polymer composition, such as at least 60 wt %, especially at least 80 wt %, such as at least 90 wt % of the semiconductive polymer composition, based on the total weight of the layer.

A further embodiment of the present invention provides a layer in a multi-layer cable, such as a power cable layer, wherein said layer comprises the semiconductive polymer composition as described herein. The multi-layer cable may e.g. have at least 3 layers, such as e.g. an inner semiconductive layer, an outer semiconductive layer, and an insulation layer arranged there between.

The at least one layer of the cable comprising the semiconductive polymer composition is preferably a semiconductive layer.

Ideally, the cable will comprise a conductor surrounded by at least an inner semiconductive layer, an insulation layer and an outer semiconductive layer in given order, wherein the semiconductive layer(s) comprise, preferably consist of, the semiconductive polymer composition as described herein. It is within the ambit of the invention for the semiconductive polymer composition of the inner and outer semiconductive layer to be identical or different.

According to another embodiment of a power cable, the semiconductive layer(s) may be strippable or non-strippable, preferably non-strippable, i.e. bonded. These terms are known and describe the peeling property of the layer, which may be desired or not depending on the end application. Thus, according to at least one example embodiment, said layer is a bonded layer in said multi-layer cable.

The cable of the invention is preferably a power cable selected from a MV, HV or EHV cable. The cable is preferably a MV cable, HV cable or EHV cable.

Insulating layers for medium or high voltage power cables generally have a thickness of at least 2 mm, typically of at least 2.3 mm, and the thickness increases with increasing voltage the cable is designed for.

As well known the cable can optionally comprise further layers, e.g. layers surrounding the insulation layer or, if present, the outer semiconductive layers, such as screen(s), a jacketing layer(s), other protective layer(s) or any combinations thereof.

The cable of the invention may be crosslinkable. Accordingly, further preferably the cable is a crosslinked cable, wherein at least one semiconductive layer comprises crosslinkable polymer composition of the invention which is crosslinked before the subsequent end use.

The most preferred cable of the invention is a power cable which is preferably crosslinkable. Such a power cable ideally comprises a conductor surrounded by at least an inner semiconductive layer, an insulation layer and an outer semiconductive layer in given order, wherein the semiconductive layer(s) comprises, preferably consists of, the semiconductive polymer composition as described herein. Preferably at least the inner semiconductive layer comprises the polymer composition of the invention, as defined above or below, or in claims, including the preferred embodiments thereof. In this preferred embodiment of cable, the outer semiconductive layer may optionally comprise the polymer composition of the invention which can be identical or different from the polymer composition of the inner semiconductive layer. Moreover, at least the polymer composition of the invention of the inner semiconductive layer is crosslinkable, preferably peroxide crosslinkable, and is crosslinked before the subsequent end use. Preferably also the insulation layer is crosslinkable and is crosslinked before the subsequent end use.

In one embodiment, the cable of the invention is a power cable which is non-crosslinked or non-crosslinkable comprising at least one non-crosslinked or non-crosslinkable inner/outer semiconductive or insulation layer.

The invention further provides a process for producing a cable, preferably a power cable, wherein the process comprises the steps of:

applying on one or more conductors, a layer comprising a semiconductive polymer composition as defined herein. A cable can be produced by the process comprising the steps of:
(a) providing and mixing, for example, melt mixing in an extruder, a crosslinkable first semiconductive polymer composition for the inner semiconductive layer,
   providing and mixing, for example, melt mixing in an extruder, a crosslinkable insulation composition for the insulation layer,
   providing and mixing, for example, melt mixing in an extruder, a second semiconductive polymer composition for the outer semiconductive layer,
(b) applying on a conductor, for example, by co-extrusion,
   a melt mix of the first semiconductive polymer composition obtained from step (a) to form the inner semiconductive layer,
   a melt mix of insulation layer composition obtained from step (a) to form the insulation layer, and
   a melt mix of the second semiconductive polymer composition obtained from step (a) to form the outer semiconductive layer, and
(c) optionally crosslinking at crosslinking conditions one or more of the insulation layer, the inner semiconductive layer and the outer semiconductive layer, of the obtained cable.

One or both of the inner and/or outer semiconductive layers are produced using the semiconductive polymer composition of the invention.

Moreover said first and second semiconductive polymer compositions may, for example, be identical.

The term “(co)extrusion” means herein that in case of two or more layers, said layers can be extruded in separate steps, or at least two or all of said layers can be coextruded in a same extrusion step, as well known in the art. The term “(co)extrusion” means herein also that all or part of the layer(s) are formed simultaneously using one extrusion head, or sequentially using more than one extrusion heads.

As well known a meltmix of the polymer composition or component(s) thereof, is applied to form a layer. The mixing step can be carried out in the cable extruder. The meltmixing step may comprise a separate mixing step in a separate mixer, e.g. kneader, arranged in connection and preceding the cable extruder of the cable production line. Mixing in the preceding separate mixer can be carried out by mixing with or without external heating (heating with an external source) of the component(s).

All or part of the optional other component(s), such as further polymer component(s) or additive(s) can be present in the polymer composition before providing to the mixing step (i) of the cable preparation process or can be added, e.g. by the cable producer, during the mixing step (i) of the cable production process.

If, and preferably, the polymer composition is crosslinked after cable formation, then the crosslinking agent is preferably a peroxide, which can be mixed with the components of the polymer composition before or during mixing step (i). Preferably, the crosslinking agent, preferably peroxide, is impregnated to the solid polymer pellets of the polymer composition. The obtained pellets are then provided to the cable production step.

Most preferably, the polymer composition of the invention is provided to the mixing step (i) of the cable production process in a suitable product form, such as a pellet product.

As mentioned, the polymer composition is preferably crosslinkable and preferably the pellets of the polymer composition comprise also the peroxide before providing to the cable production line.

In above crosslinking process step (iii) of the invention crosslinking conditions can vary depending i.e. on the used crosslinking method, and cable size. The crosslinking of the invention is effected e.g. in a known manner preferably in an elevated temperature. A skilled person can choose the suitable crosslinking conditions e.g. for crosslinking via radical reaction or via hydrolysable silane groups. As non-limiting example of a suitable crosslinking temperature range, e.g. at least 150° C. and typically not higher than 360° C.

### Insulation Layer

The cable of the invention comprises an insulation layer. Preferably this insulation layer comprises an LDPE homopolymer and/or copolymer such as an LDPE copolymer and optionally a peroxide. The insulation layer may comprise a mixture of LDPE homopolymer and/or copolymers such as LDPE copolymers.

The LDPE is preferably an LDPE homopolymer or an LDPE copolymer with at least one polyunsaturated comonomer. In one embodiment, the insulation layer does not contain an ethylene alkyl (meth)acrylate copolymer.

If the LDPE homopolymer or copolymer is a copolymer such as an LDPE copolymer, it preferably comprises at least one polyunsaturated comonomer and optionally with one or more other comonomer(s). Preferably, the LDPE copolymer is a binary copolymer of ethylene and one polyunsaturated comonomer only. The polyunsaturated comonomer may be a diene such as 1,7-octadiene, 1,9-decadiene, 1,11-dodecadiene, 1,13-tetradecadiene, 7-methyl-1,6-octadiene, 9-methyl-1,8-decadiene, or mixtures thereof, e.g., from 1,7-octadiene, 1,9-decadiene, 1,11-dodecadiene, 1,13-tetradecadiene, or any mixture thereof.

The invention will now be described with reference to the following non limiting examples. In the examples all percentages and parts are by weight, unless otherwise stated.

Determination Methods Unless otherwise stated in the description or experimental part the following methods were used for the property determinations.
wt %: % by weight

### Melt Flow Rate

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR is determined at 190° C. for polyethylenes and may be determined at different loadings such as 2.16 kg (MFR₂) or 21.6 kg (MFR₂₁).

### Density

The density was measured according to ISO 1183-1/method A. The sample preparation was executed according to ISO 1872-2 Table 3 Q (compression moulding).

### Oil Absorption Number

Oil Absorption number in ml/100 g is measured according to ASTM D 2414-19.

### Iodine Adsorption Number

The iodine adsorption no. is expressed in g/kg and measured according to ASTM D 1510-19a.

### Average Primary Particle Size

The average primary particle size of the carbon black is expressed as the mean particle size measured in nanometers (nm) with transmission electron microscopy according to ASTM D 3849-14a.

### Volume Resistivity

The volume resistivity (VR) was measured on extruded tapes, which were prepared in a 20/25D mm single screw extruder with a screw configuration with low compression 1:1.5. The die dimension was 30×0.8 mm and the extrusion temperature was 120° C. to 125° C. The tape had a thickness h between 0.1 and 3 mm, preferably around 1 mm, a width w between 5 and 25 mm, preferably around 12 mm and a length L of 10 to 1000 mm, preferably around 100 mm. The thickness and width was measured using calipers and the length with a ruler, both recorded in centimeters. The resistance R was measured in ohms using an ohm-meter. The area A was calculated as A=h*w. The volume resistivity VR was calculated as VR=R*A/L.

### Comonomer Content

Comonomer content (wt %) was determined in a known manner based on Fourier transform infrared spectroscopy (FTIR) determination calibrated with quantitative nuclear magnetic resonance (NMR) spectroscopy.

Films were pressed using a Specac film press at 150° C., approximately at 5 tons, 1-2 minutes, and then cooled with cold water in a not controlled manner. The accurate thickness of the obtained film samples was measured.

After the analysis with FTIR, base lines in absorbance mode were drawn for the peaks to be analysed. The absorbance peak for the comonomer was normalised with the absorbance peak of polyethylene. An FTIR peak height ratio was correlated to the polar comonomer content by reference materials determined by NMR. The NMR spectroscopy calibration procedure was undertaken in the conventional manner which is well documented in the literature.

Quantification of polar comonomer content in in polymers by NMR spectroscopy:

The polar comonomer content was determined by quantitative nuclear magnetic resonance (NMR) spectroscopy after basic assignment (e.g. “NMR Spectra of Polymers and Polymer Additives”, A. J. Brandolini and D. D. Hills, 2000, Marcel Dekker, Inc. New York). Experimental parameters were adjusted to ensure measurement of quantitative spectra for this specific task (e.g “200 and More NMR Experiments: A Practical Course”, S. Berger and S. Braun, 2004, Wiley-VCH, Weinheim). Quantities were calculated using simple corrected ratios of the signal integrals of representative sites in a manner known in the art.

Below is exemplified the determination of the polar comonomer content of ethylene ethyl acrylate.

The weight-% can be converted to mol-% by calculation. It is well documented in the literature.

### Ethylene Copolymers Containing Ethyl Acrylate:

Film samples of the polymers were prepared for the FTIR measurement: 0.5 mm thickness was used for ethylene ethyl acrylate.

After the FT-IR analysis the maximum absorbance for the peak for the ethyl acrylate at 3450 cm⁻¹ with linear baseline correction applied between approximately 3205 and 3295 cm⁻¹ (A_{ethylacrylate}) was determined. Then the maximum absorbance peak for the polyethylene peak at 2020 cm⁻¹ with linear baseline correction applied between approximately 1975 and 2120 cm⁻¹ was determined (A₂₀₂₀). The ratio between (A_{ethylacrylate}) and (A₂₀₂₀) was then calculated in the conventional manner which is well documented in the literature.

### Surface Smoothness Analysis (SSA) Method

### Sample Preparation

A flat tape with a width of 0.5 mm and thickness of 30 mm was produced by extrusion with each sample. The extruder was a 25 L/D single screw extruder with a screw diameter of 30 mm and the final melt temperature of the sample was 125° C., the extruder die opening had a width of 50 mm and a height of 1 mm.

### Surface Smoothness Measurement

Surface smoothness i.e., particles protruding upwards from the tape surface, was determined by optical inspection of the tape surface. In inspection the tape was continuously analysed by a high resolution camera scanning the surface, and possible protrusions on it. Protrusions were analysed for their height, width and the position in the tape. The area scanned for each sample was 2.1 m². Protrusions are then classified to different size classes based on their width at half of their height (W₅₀). Protrusions are divided into 4 size classes. Protrusions with W₅₀>0.15 mm, protrusions with W₅₀>0.20 mm, protrusions with W₅₀>0.5 mm and protrusions with W₅₀>1 mm. Only protrusions with a height larger than 45 μm were counted. Result is reported as number of protrusions/m² per size class. An example of the instrument used for analysis is model ME30-V3 by the vendor OCS.

### Example 1

The inventive example and the comparative example have been prepared on the same type of compounding equipment using the same carbon black loading and same CB feed characteristics.

The compositions were compounded in the co-kneader BUSS MX140 mixer at a throughput of 3300 kg/h and a rotational speed of 620 rpm and was then pelletized.

In both examples, an ethylene ethyl acrylate copolymer (EEA) has been used as the polymer in the semiconductive polymer composition having an EA content of 15 wt % and a MFR 2=7.5 g/10 min. The inventive and comparative compositions and the amounts of carbon black and antioxidant that were added are described in Table 1 together with the measured volume resistivity VR.

The carbon black used in the semiconductive polymer composition has the following carbon black features:
Iodine adsorption number=118 mg/g,
OAN=98 ml/100 g
An average primary particle size of ≤20 nm.

TABLE 1

| Component | Inventive Ex 1 | Comparative Ex 1 |
|---|---|---|
| EEA (wt %) | 60.6 | 60.2 |
| CB (wt %) | 39.0 | 39.0 |
| AO content (wt %) | 0.4 | 0.8 |
| AO type | 4,4′-bis(1,1′-dimethylbenzyl) | TMQ |
| | diphenylamine | |
| VR 23° C. (Ωcm) | 5.7 | 7.3 |

4,4′-bis(1,1′-dimethylbenzyl)diphenylamine (CAS-no. 10081-67-1) and TMQ is 2,2,4-trimethyl-1,2-dihydroquinoline polymer.

The surface smoothness results are summarised in Table 2.

TABLE 2

| Protrusion size | Inventive Ex 1 | Comparative Ex 1 |
|---|---|---|
| class (mm) | (number of protrusions/m²) | (number of protrusions/m²) |
| W50 > 0.15 mm | 51 | 62 |
| W50 > 0.20 mm | 9 | 12 |
| W50 > 0.50 mm | 0 | 0 |
| W50 > 1 mm | 0 | 0 |

As can be seen the inventive semiconductive polymer composition both has an improved smoothness level as well as an improved VR value compared to the Comparative composition.

1. A semiconductive polymer composition comprising:
(a) an ethylene alkyl (meth)acrylate copolymer;
(b) 15 to 48 wt % carbon black having an iodine adsorption number of 85 to 140 mg/g (ASTM D 1510-19a), an oil absorption number of 90 to 110 ml/100 g (ASTM D 2414-19) and an average particle size of 29 nm or less (ASTM D 3849-14a); and
(c) 0.05 to 2.0 wt°/0 of 4,4′-bis(1,1′-dimethylbenzyl)diphenylamine;
all weight percentages being based on the total weight of the semiconductive polymer composition.

2. The semiconductive polymer composition as claimed in claim 1, wherein the ethylene alkyl (meth)acrylate copolymer is ethylene methyl acrylate, ethylene ethyl acrylate or ethylene butyl acrylate.

3. The semiconductive polymer composition as claimed in claim 1, comprising at least 54 wt % of said ethylene alkyl (meth)acrylate copolymer based on the total weight of the semiconductive polymer composition.

4. The semiconductive polymer composition as claimed in claim 1, wherein said ethylene alkyl (meth)acrylate copolymer comprises 9 wt % or more of said alkyl (meth)acrylate comonomer based on the total weight of the ethylene alkyl (methyl)acrylate copolymer and/or has an MFR2 of 4.0 g/10 min or more (determined using ISO 1133 190° C. and 2.16 kg load).

5. The semiconductive polymer composition as claimed in claim 1, wherein said carbon black has an iodine adsorption number of 100 to 130 mg/g (ASTM D 1510-19a), an oil absorption number of 92 to 105 ml/100 g (ASTM D 2414-19) and an average primary particle size of 25 nm or less (ASTM D 3849-14a).

6. The semiconductive polymer composition as claimed in claim 1, wherein said carbon black forms 25 to 45 wt % of the semiconductive polymer composition, based on the total weight of the semiconductive polymer composition.

7. The semiconductive polymer composition as claimed in claim 1, which is free of other antioxidants.

8. The semiconductive polymer composition as claimed in claim 1, further comprising 0.1 to 2.0 wt % peroxide, based on the total weight of the semiconductive polymer composition.

9. The semiconductive polymer composition as claimed in claim 1, having a volume resistivity (VR) at 23° C. of less than 100 Ohm·cm.

10. A process for the preparation of the semiconductive polymer composition as claimed in claim 1, the process comprising:
compounding components (a) to (c) at a temperature of 150 to 300° C.;
and optionally pelletizing the composition.

11. A cable comprising:
a conductor which is surrounded by at least an inner semiconductive layer, an insulation layer and an outer semiconductive layer in that order;
wherein said inner and/or outer semiconductive layer comprises the semiconductive polymer composition as defined in claim 1.

12. The cable as claimed in claim 11, wherein said inner and/or outer semiconductive layer comprising the semiconductive polymer composition is not crosslinked.

13. A process for producing a cable comprising a conductor surrounded by at least an inner semiconductive layer, an insulation layer and an outer semiconductive layer, in that order, wherein the process comprises the steps of
extruding on the conductor the inner semiconductive layer, the insulation layer and outer semiconductive layer; and
optionally crosslinking one or more of said inner semiconductive layer, insulation layer and outer semiconductive layer;
wherein said inner and/or outer semiconductive layer comprises the semiconductive polymer composition as defined in claim 1.

14. A method of use of the semiconductive polymer composition as defined in claim 1, the method comprising using the semiconductive polymer composition in the manufacture of the inner and/or outer semiconductive layer of a cable.

15. A method of use of a semiconductive polymer composition comprising:
(a) an ethylene alkyl (meth)acrylate copolymer;
(b) 15 to 48 wt % carbon black having an iodine adsorption number of 85 to 140 mg/g (ASTM D 1510-19a), an oil absorption number of 90 to 110 ml/100 g (ASTM D 2414-19) and an average primary particle size of 29 nnn or less (ASTM D 3849-14a); and
(c) 0.05 to 2.0 wt % of 4,4′bis(1,1′-dimethylbenzyl)diphenylamine;
all weight percentages being based on the total weight of the semiconductive polymer composition;
the method comprising using the semiconductive polymer composition to increase the smoothness of a semiconductive shield layer prepared using said composition.

16. The semiconductive polymer composition as claimed in claim 1, wherein the ethylene alkyl (meth)acrylate copolymer is an ethylene methyl acrylate or ethylene ethyl acrylate.

17. The semiconductive polymer composition as claimed in claim 1, comprising 54 to 85 wt % of said ethylene alkyl (meth)acrylate copolymer based on the total weight of the semiconductive polymer composition.

18. The semiconductive polymer composition as claimed in claim 1, wherein said ethylene alkyl (meth)acrylate copolymer comprises 10 to 20 wt % of said alkyl (meth)acrylate comonomer based on the total weight of the ethylene alkyl (methyl)acrylate copolymer.

19. The semiconductive polymer composition as claimed in claim 1, wherein said ethylene alkyl (meth)acrylate copolymer has an MFR2 of 4.0 to 15 g/10 min (determined using ISO 1133 190° C. and 2.16 kg load).

20. The cable of claim 11, wherein said inner and/or outer semiconductive layers consist of the semiconductive polymer composition.
